(19) United States
(12) Patent Application Publication
(10) Pub. No.: US 2010/0156878 A1
(43) Pub. Date: Jun. 24, 2010

(54) SYSTEMS FOR DRIVING DISPLAYS

(75) Inventors: Tai-Ann Chen, Sindian City (TW); Chih-Jen Chen, Yongkang City (TW); Chiao-Nan Huang, Sijhou Township (TW); Chao-Ching Liang, Jhonghe City (TW)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: INDUSTRIAL TECHNOLOGY RESEARCH INSTITUTE, Chutung (TW)

(21) Appl. No.: 12/337,626

(22) Filed: Dec. 18, 2008

(51) Int. Cl. G06F 3/038

(52) U.S. Cl. 345/212

(57) ABSTRACT

A system is configured to drive a display device having a number of cholesteric liquid crystal (CHLC) pixels. The system comprises a processor configured to receive a first set of gray levels for a first image frame and a second set of gray levels for a second image frame, wherein the first set of gray levels is related to a first intensity state of each of the CHLC pixels in the first image frame and the second set of gray levels is related to a second intensity state of each of the CHLC pixels in the second image frame, and a look-up table (LUT) configured to output a third set of gray levels based on the first set of gray levels and the second set of gray levels, wherein the third set of gray levels is related to an addressing voltage to be written to each of the CHLC pixels so as to change each of the CHLC pixels from the first intensity state to the second intensity state.

### BACKGROUND OF THE INVENTION

The present invention relates to liquid crystal displays and, more particularly, to systems for driving displays having a cholesteric liquid crystal material.

Nowadays, liquid crystal displays may have taken the place of traditional displays because of low power consumption. Moreover, remarkable advance in liquid crystal material research has resulted in the discovery of bistable chiral nematic liquid crystal materials or cholesteric liquid crystal (CHLC) materials. Generally, CHLC may exhibit grey scale properties depend on a voltage value applied thereto. Moreover, CHLC materials may consume less power than other liquid crystal materials because the former may be able to remain a given state in absence of an electric field applied thereto. Accordingly, CHLC displays may advantageously provide relatively high luminance and contrast.

Many driving schemes have been proposed to drive a CHLC display. An example of the conventional driving schemes may include the steps of refreshing one of a number of “N” rows in a frame followed by addressing the one of the rows until all of the rows in the frame are refreshed and addressed. Accordingly, a frame time T_{FRAME} required to drive the frame may be calculated below.

T_{FRAME}=T_{RESET}×N+T_{ADDRESSING}×N

Where T_{RESET} is the time required to refresh each row and T_{ADDRESSING} is the time required to address the each row.

Another example of the conventional driving schemes may include the steps of refreshing all of the “N” rows at a time and then addressing each of the rows in the frame. Accordingly, the frame time T_{FRAME} may be calculated below.

T_{FRAME}=T_{RESET}+T_{ADDRESSING}×N

The later driving scheme may be more efficient than the former one in view of the frame time required. However, with the increasing interest in display devices with faster response speeds and higher data rates, it may be desirable to have a driving scheme with a faster driving time than the conventional driving schemes.

### BRIEF SUMMARY OF THE INVENTION

Examples of the present invention may provide a system for driving a display device having a number of cholesteric liquid crystal (CHLC) pixels. The system comprises a processor configured to receive a first set of gray levels for a first image frame and a second set of gray levels for a second image frame, wherein the first set of gray levels is related to a first intensity state of each of the CHLC pixels in the first image frame and the second set of gray levels is related to a second intensity state of the each of the CHLC pixels in the second image frame, and a look-up table (LUT) configured to output a third set of gray levels based on the first set of gray levels and the second set of gray levels, wherein the third set of gray levels is related to an addressing voltage to be written to each of the CHLC pixels so as to change each of the CHLC pixels from the first intensity state to the second intensity state.

Some examples of the present invention may also provide a system for driving a display device having a number of cholesteric liquid crystal (CHLC) pixels. The system comprises a sensor configured to detect a first set of gray levels of the CHLC pixels for a first image frame displayed on the display device, wherein the first set of gray levels is related to a first intensity state of each of the CHLC pixels in the first image frame, a processor configured to receive a second set of gray levels for a second image frame, wherein the second set of gray levels is related to a second intensity state of the each of the CHLC pixels in the second image frame, and a look-up table (LUT) configured to output a third set of gray levels based on the first set of gray levels from the sensor and the second set of gray levels from the processor, wherein the third set of gray levels is related to an addressing voltage to be written to each of the CHLC pixels so as to change each of the CHLC pixels from the first intensity state to the second intensity state.

Examples of the present invention may further provide a system for driving a display device having a number of cholesteric liquid crystal (CHLC) pixels. The system comprises a processor configured to receive a first set of gray levels for a first image frame and a second set of gray levels for a second image frame, wherein the first set of gray levels is related to a first intensity state of each of the CHLC pixels in the first image frame and the second set of gray levels is related to a second intensity state of the each of the CHLC pixels in the second image frame, a sensor configured to detect a third set of gray levels of the CHLC pixels for the first image frame displayed on the display device, wherein the third set of gray levels is related to a third intensity state of each of the CHLC pixels displayed in the first image frame, a first look-up table (LUT) configured to output an index based on the first set of gray levels and the third set of gray levels, wherein the index is related to an environmental change, and a second LUT configured to output a fourth set of gray levels based on the second set of gray levels from the processor, the third set of gray levels from the sensor and the index from the first LUT, wherein the fourth set of gray levels is related to an addressing voltage to be written to each of the CHLC pixels so as to change each of the CHLC pixels from the third intensity state to the second intensity state.

Other objects, advantages and novel features of the present invention will be drawn from the following detailed examples of the present invention with attached drawings.

### BRIEF DESCRIPTION OF THE SEVERAL VIEWS OF THE DRAWINGS

The foregoing summary as well as the following detailed description of the preferred embodiments of the present invention will be better understood when read in conjunction with the appended drawings. For the purposes of illustrating the invention, there are shown in the drawings embodiments which are presently preferred. It is understood, however, that the invention is not limited to the precise arrangements and instrumentalities shown. In the drawings:

FIG. 1A is a bock diagram of a system for driving a display device in accordance with an example of the present invention;

FIG. 1B is a plot illustrating reflectance of a cholesteric liquid crystal (CHLC) pixel at different voltage levels;

FIG. 1C is a bock diagram of a system for driving a display device in accordance with another example of the present invention;

FIG. 1D is a schematic diagram illustrating a driving scheme of the system illustrated in FIGS. 1A and 1C;

FIG. 2A is a bock diagram of a system for driving a display device in accordance with another example of the present invention;

FIGS. 2B and 2C are respectively a front view and a top view of a writehead illustrated in FIG. 2A;

FIG. 2D is a bock diagram of a system for driving a display device in accordance with another example of the present invention;

FIG. 3A is a bock diagram of a system for driving a display device in accordance with another example of the present invention; and

FIG. 3B is a bock diagram of a system for driving a display device in accordance with another example of the present invention.

### DETAILED DESCRIPTION OF THE INVENTION

Reference will now be made in detail to the present examples of the invention illustrated in the accompanying drawings. Wherever possible, the same reference numbers are used throughout the drawings to refer to the same or like elements.

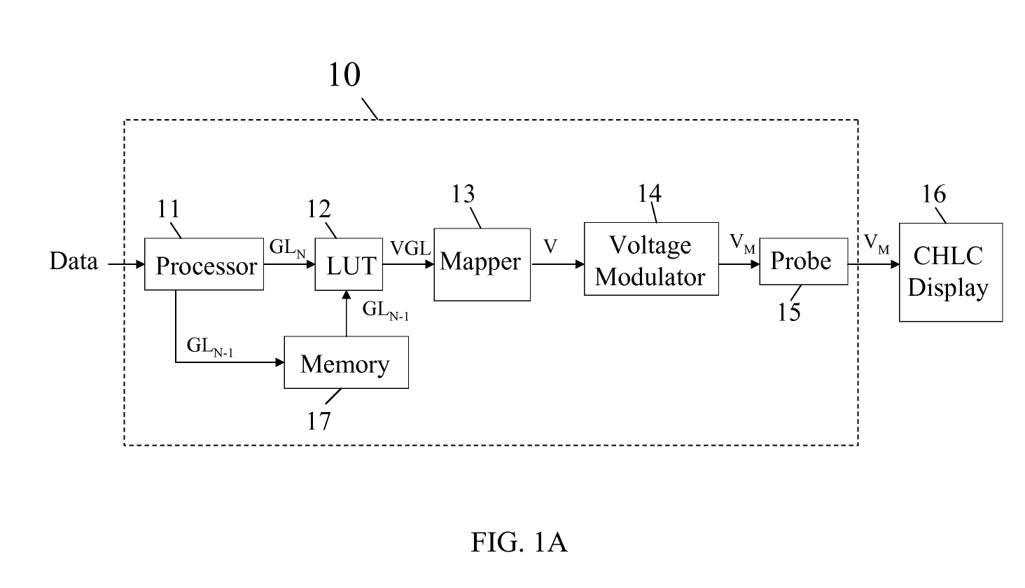

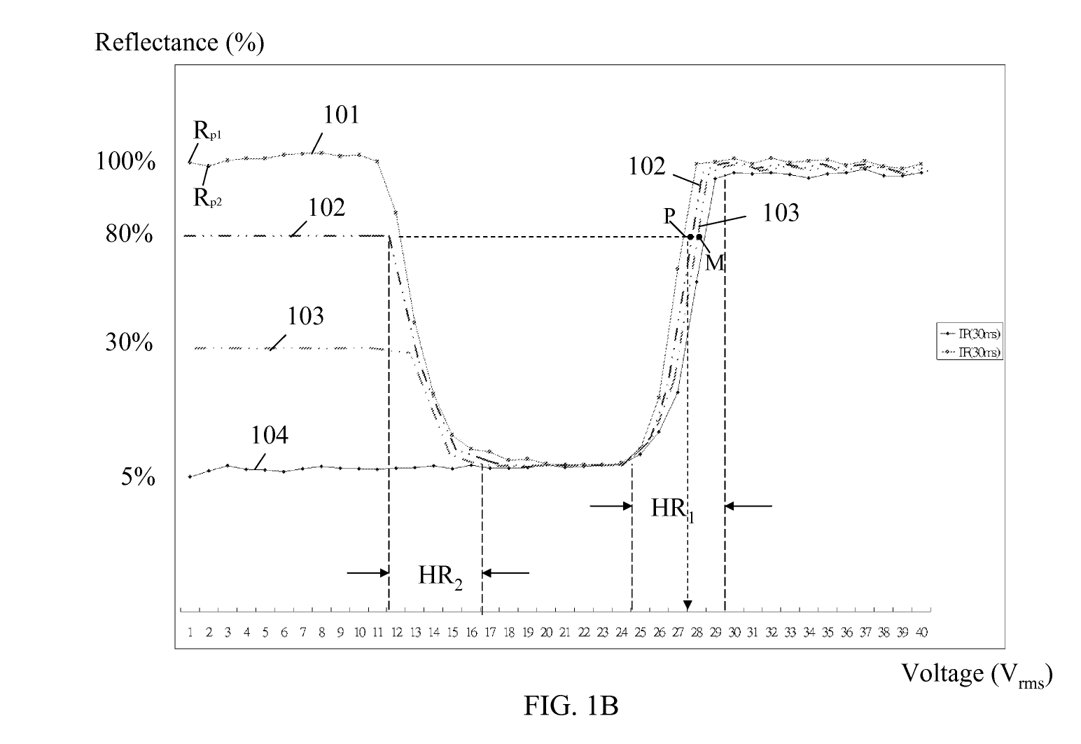

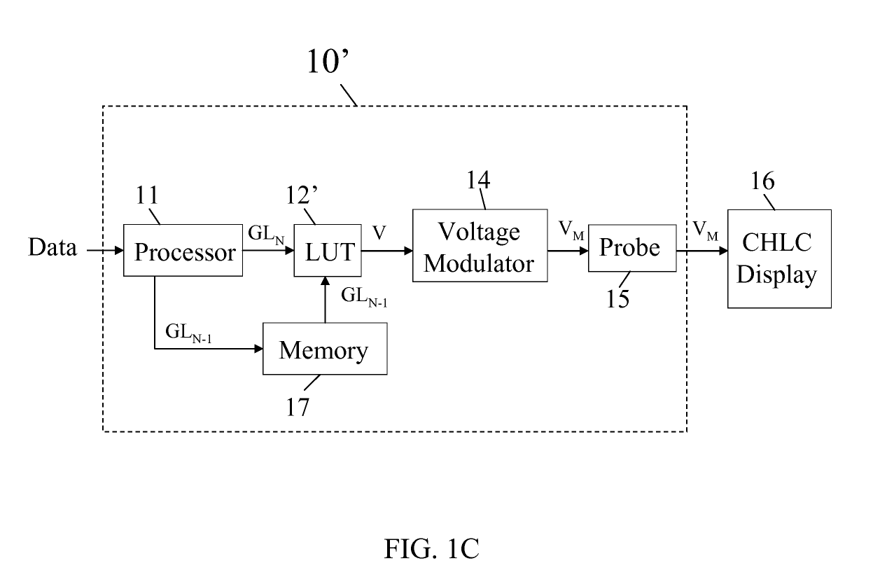

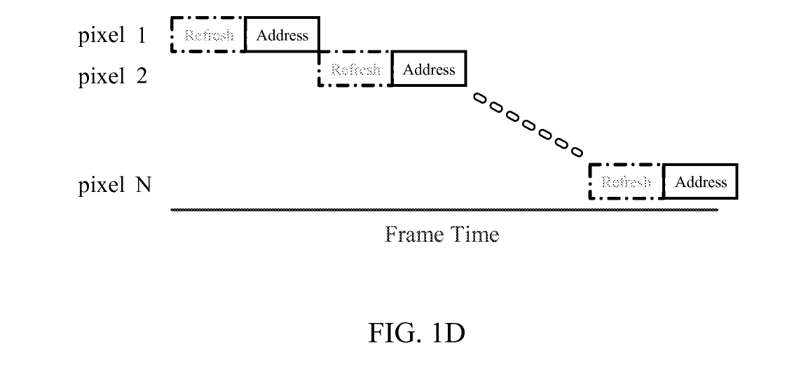

FIG. 1A is a bock diagram of a system 10 for driving a display device in accordance with an example of the present invention. Referring to FIG. 1A, the system 10 may include a processor 11, a look-up table (LUT) 12 and a memory 17. The processor 11 may be configured to receive data such as gray levels of pixels of an image frame and identify a reflectance level for each of the gray levels based on a reflectance-voltage (RV) curve as illustrated in FIG. 1B, which will be discussed later. Specifically, the processor 11 may receive a first set of gray levels GL_{N-1} of a first image frame and send the same to the memory 17. The first set of gray levels may include intensity information on each pixel of the first image frame. For example, each of the first set of gray levels may range from 0 to 255, wherein the gray levels 0 and 255 may represent full black and full white, respectively. Next, the processor 11 may receive a second set of gray levels GL_{N} of a second image frame immediately after the first image frame and may send the same to the memory 17. The first set of gray levels GL_{N-1} may serve as a first index to the LUT 12 while the second set of gray levels GL_{N} may serve as a second index. In the present example, the first index, i.e., the gray levels GL_{N-1} of the CHLC pixels, may be related to the current state of the CHLC pixels, and the second index, i.e., the gray levels GL_{N}, may be related to a next state of the CHLC pixels to be displayed on a CHLC display device 16. The LUT 12 may output a set of voltage gray levels “VGL” based on the first index and the second index. The set of voltage gray levels VGL may include a set of codes, which may be related to a set of addressing voltages for driving each of the CHLC pixels from a first reflectance level related to one of the first gray levels GL_{N-1} to a second reflectance level related to one of the second gray levels GL_{N}, as will be discussed below with reference to FIG. 1B.

FIG. 1B is a plot illustrating reflectance of a CHLC pixel at different voltage levels. Referring to FIG. 1B, curves 101 and 104 may respectively represent the CHLC pixel initially disposed at a relatively high reflectance state having a reflectance level of approximately 100% (planar configuration; hereinafter an “initial P” state) and a relatively low reflectance state having a reflectance level of approximately 5% (focal conic configuration; hereinafter an “initial F” state). Furthermore, curves 102 and 103 may represent the CHLC pixel initially disposed at a reflectance state having a reflectance level of approximately 80% and another reflectance state having a reflectance level of approximately 30%, respectively. The curves 101 to 104 may be obtained in a process as given below.

Firstly, a CHLC pixel may be refreshed to the initial P state or the initial F state. Taking the initial P state as an example, it may be identified that when a voltage of approximately 40 volts (V) is applied, a maximum reflectance level may be reached. A voltage of approximately 20V may be applied to the CHLC for duration of 30 milliseconds (ms), which is long enough to change the CHLC pixel from the initial P state to the initial F state. A voltage source providing the 40V voltage level may then be removed. Subsequently, a voltage of approximately 1V is applied, resulting in a first point R_{P1}. Next, the refreshing step may be repeated by applying the 40V voltage level to the CHLC for 30 ms and then removing the voltage source. Subsequently, an addressing step may be repeated by applying a voltage of approximately 2V, resulting in a second point R_{P2}. The refreshing step followed by an addressing step may be repeated by using the 40V voltage level as a refresh voltage and using voltages of 3V to 40V as an addressing voltage one at a time. Consequently, the curve 101 may be obtained.

In plotting the curve 101, it may be identified that when a voltage of approximately 22V is applied, a minimum reflectance level may be reached. The curve 104 may be obtained in a similar fashion by using a 22V voltage as a refresh voltage while using voltages of 1V to 40V as an addressing voltage one at a time.

Likewise, in plotting the curve 101, it may be identified that when a voltage of approximately 26.5V is applied, a 30% reflectance level may be reached. The curve 103 may be obtained in a similar fashion by using a 26.5V voltage as a refresh voltage while using voltages of 1V to 40V as an addressing voltage one at a time.

Likewise, in plotting the curve 101, it may be identified that when a voltage of approximately 28V is applied, an 80% reflectance level may be reached. The curve 102 may be obtained in a similar fashion by using a 28V voltage as a refresh voltage while using voltages of 1V to 40V as an addressing voltage one at a time. Skilled persons in the art will understand that other curves representing other reflectance levels may be obtained even though only four curves 101 to 104 are illustrated.

Generally, CHLC material may exhibit different reflectance levels when a given voltage is applied thereto. For example, in a first hysteresis region HR₁, if a voltage of, for example, 27V, is applied, the CHLC pixel may exhibit four different reflectance levels corresponding to the curves 101 to 104, which is undesirable. Alternatively, if an 80% reflectance, for example, is to be written in a next frame for a CHLC pixel, four different voltage levels corresponding to the curves 101 to 104 may be possible, which is also undesirable. To identify an addressing voltage from the curves 101 to 104, voltage levels in one of the first hysteresis region HR₁ ranging from approximately 25V to 30V and a second hysteresis region HR₂ ranging from approximately 12V to 17V may be coded in gray level. Taking the first hysteresis region HR₁ as an example, the voltages 25V, 26.5V, 28V and 30V in this region may be coded in a coding algorithm into “00,” “01,” “10” and “11,” respectively. The voltage gray levels may be stored in the LUT 12 illustrated in FIG. 1A. In the present example, a two-bit digital code or gray level may be used to represent one of four voltage levels in the first hysteresis region HR₁. In another example, an eight-bit digital code or gray level may be used to represent one of 256 voltage levels in one of the hysteresis regions HR₁ and HR₂.

Furthermore, the gray level GL_{N} or GL_{N-1} of each pixel may correspond to one of the reflectance levels represented by the curves 101 to 104. For example, a gray level of the CHLC pixel ranging from 0 to 2 may correspond to the 5% reflectance curve 104, and a gray level ranging from 235 to 255 may correspond to the 100% reflectance curve 101.

Referring back to FIG. 1A, the LUT 12 may be configured to output a voltage gray level VGL for a CHLC pixel based on a first gray level GL_{N-1} and a second gray level GL_{N}. For example, it may be identified that a previous state of a CHLC pixel is 30% reflectance level based on the first gray level GL_{N-1} of the CHLC pixel. Accordingly, the 30% reflectance curve 103 may be identified. Next, it may be identified that the next state of the CHLC pixel is an 80% reflectance level based on the second gray level GL_{N} of the CHLC pixel. Also referring to FIG. 1B, an intersection point “M” on the 30% reflectance curve 103 where a line representing the 80% reflectance level intersects may be identified. Next, an intersection point “P” on the 80% reflectance curve 102 where the line representing the 80% reflectance level intersects may then be identified, and in turn a voltage level of approximately 28V in the first hysteresis region HR₁ may be identified. The LUT 12 may output a voltage gray level corresponding to a voltage of 28V. The system 10 may further include a mapper 13 and a voltage modulator 14. The mapper 13, for example, a Gamma mapper, may be configured to map the voltage gray level VGL from the LUT 12 with a voltage level “V” in accordance with the coding algorithm. The voltage modulator 14 may include one of an amplitude modulator, a phase modulator and a pulse width modulator, and may generate a voltage “V_{M}” based on the voltage level V from the mapper 13. In one example, the voltage generator 14 includes an amplitude modulator and generates the voltage “V_{M}” in the form of uni-polar pulse voltage or a bipolar pulse voltage, for example, 28.7V or ±28.7V, respectively. In another example, the voltage generator 14 includes a pulse width modulator and generates the voltage “V_{M}” having a pulse width dependent on a required reflectance level, for example, a pulse width modulation (PWM) voltage having an amplitude of 28.7V with a duration of 30 ms for a 100% reflectance level or a PWM voltage having an amplitude of 28.7V with a duration of 24 ms for an 80% reflectance level.

The output voltage V_{M} from the voltage modulator 14 may then be written to the CHLC pixel through a probe 15 so that the gray level of the CHLC pixel may be changed from the first state GL_{N-1} to the second state GL_{N}.

FIG. 1C is a bock diagram of a system 10′ for driving a display device in accordance with another example of the present invention. Referring to FIG. 1C, the system 10′ may be similar to the system 10 described and illustrated with reference to FIG. 1A except that, for example, the mapper 13 may be eliminated. An LUT 12′ of the current example may be configured to generate a voltage level “V” in accordance with the coding algorithm in response to the first state GL_{N-1} and the second state GL_{N}. The voltage level V may then be sent to the voltage modulator 14.

FIG. 1D is a schematic diagram illustrating a driving scheme of the system 10 illustrated in FIGS. 1A and 1C. Traditionally, as in the previously descried conventional techniques, a CHLC pixel may be refreshed to an initial P state or an initial F state before an addressing voltage is applied. According to the present invention, an addressing voltage to change a CHLC pixel from its current state to a new state may be identified by using a look-up table such as the LUT 12 and the LUT 12′ respectively, illustrated in FIGS. 1A and 1C. That is, there is no need to refresh CHLC pixels before applying a set of addressing voltages. Accordingly, the refresh time T_{RESET} in the conventional techniques may be eliminated. A frame time T_{FRAME} required to drive a number of N rows of CHLC pixels in one image frame may be calculated below.

T_{FRAME}=T_{ADDRESSING}×N

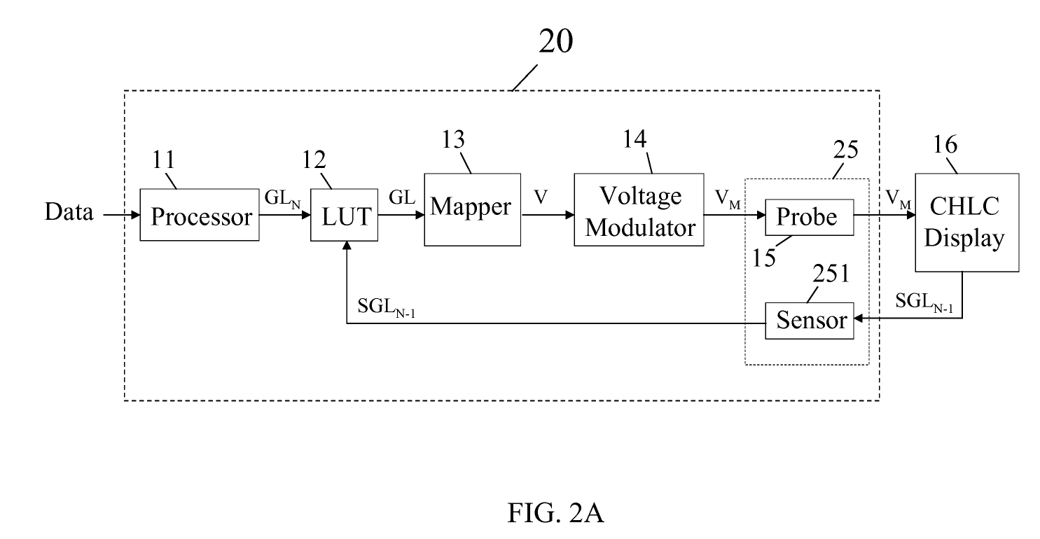

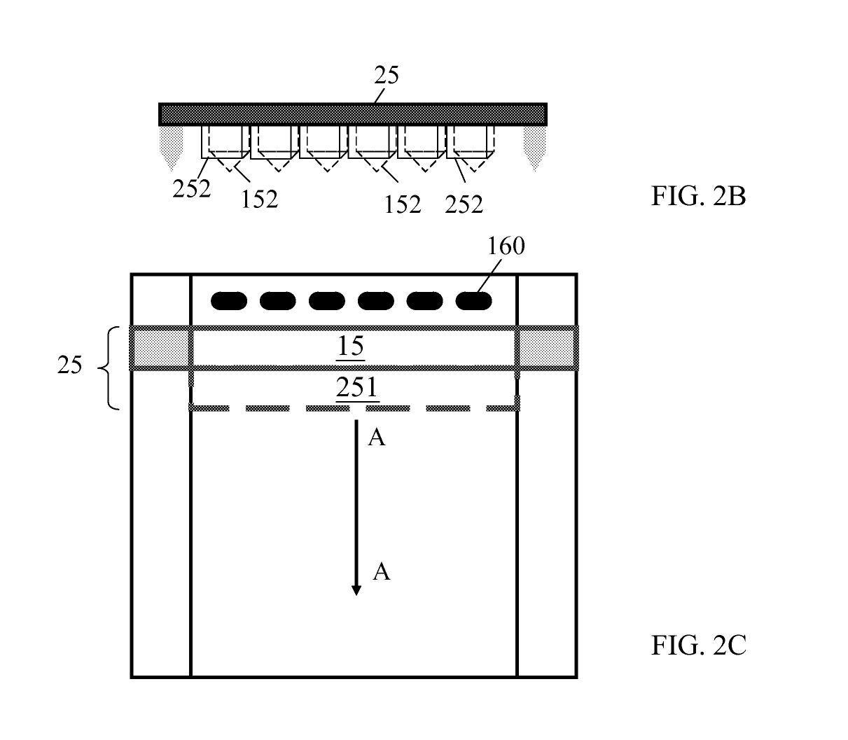

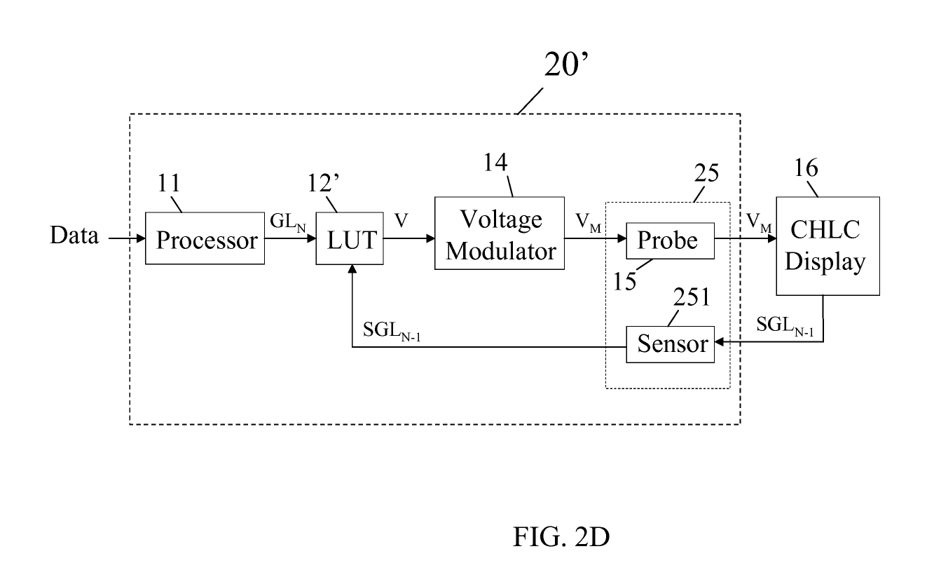

FIG. 2A is a bock diagram of a system 20 for driving a display device in accordance with another example of the present invention. Referring to FIG. 2A, the system 20 may be similar to the system 10 described and illustrated with reference to FIG. 1A except for having a writehead 25. The writehead 25 may include a sensor 251 as well as the probe 15. The sensor 251 may be configured to detect gray levels SGL_{N-1} of an (N−1)-th image frame one row after another as the probe 15 writes a set of addressing voltages to an N-th image frame one row after another. Furthermore, the sensor 251 may send the gray levels SGL_{N-1} of the (N−1)-th image frame as a first index to the LUT 12. In the system 10, the memory 17 may be used to store the gray levels GL_{N-1}, which may then serve as a first index to the LUT 12. However, the gray levels GL_{N-1} in the memory 17 may degrade and as a result the set of addressing voltages may be incorrect. To avoid the risk of gray level degradation, in the system 20, the sensor 251 replaces the memory 17. Based of the first set of gray levels SGL_{N-1} as a first index and the second set of gray levels GL_{N} as a second index, the LUT 12 may output a set of gray levels GL.

FIGS. 2B and 2C are respectively a front view and a top view of the writehead 25 illustrated in FIG. 2A. Referring to FIG. 2B, the sensor 251 may include a number of sensor elements 252 (shown in a solid line box), each of which may be configured to detect a previous state of a pixel in a row, such as a previous optical or electrical state. The probe 15 may include a number of probe elements 152 (shown in a dashed line box), each of which may be configured to write an addressing voltage to a pixel in a row.

Referring to FIG. 2C, the sensor 251 may be disposed in front of the probe 15 in view of a column direction “AA” shown by an arrow. Specifically, the sensor 251 may move along the column in AA direction and detect gray levels SGL_{N-1} of an (m+1)-th row of pixels in an (N−1)-th image frame as the probe 15 writes a set of addressing voltages to an m-th row of pixels in an N-th image frame.

FIG. 2D is a bock diagram of a system 20′ for driving a display device in accordance with still another example of the present invention. Referring to FIG. 2D, the system 20′ may be similar to the system 20 described and illustrated with reference to FIG. 2A except that, for example, the mapper 13 may be eliminated.

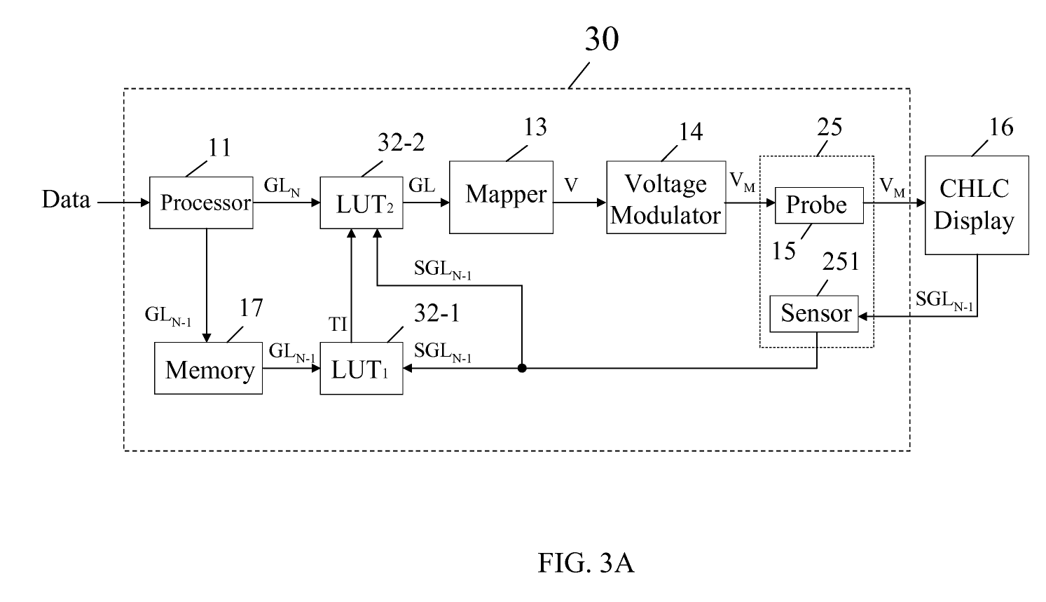

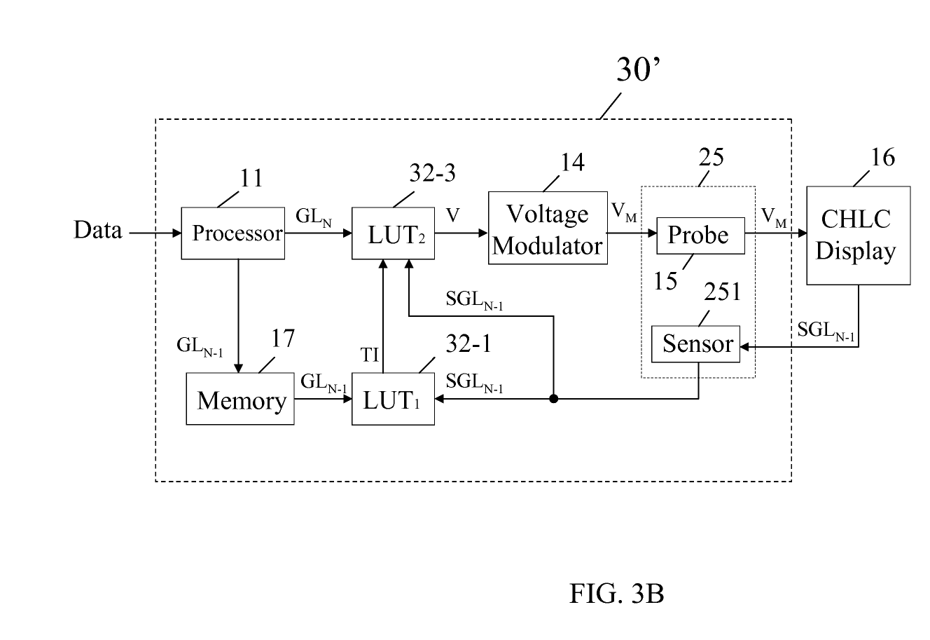

FIG. 3A is a bock diagram of a system 30 for driving a display device in accordance with another example of the present invention. Referring to FIG. 3A, the system 30 may be similar to the system 20 described and illustrated with reference to FIG. 2A except that, for example, a first LUT 32-1 and a second LUT 32-2 may replace the LUT 12 and the memory 17 may be used. CHLC material may generally be susceptible to environmental variations. As a result, a CHLC pixel may have different gray levels in different circumstances such as at temperatures, humidity, etc. even when the same addressing voltage is applied thereto. To offset the environmental effects, for example, the temperature effect in the present example, the first LUT 32-1 may be configured to output a temperature index “TI” based on the first set of gray levels GL_{N-1} from the memory 17 and the set of gray levels SGL_{N-1} detected by the sensor 251. The temperature index TI may represent a temperature change during a time period from the time the first set of gray levels GL_{N-1} is received by the processor 11 to the time the set of gray levels SGL_{N-1} is detected by the sensor 251. The second LUT 32-2 may be configured to output a set of gray levels GL based on the first index SGL_{N-1} from the sensor 251, the second index GL_{N} from the processor 11 and the temperature index TI from the first LUT 32-1.

FIG. 3B is a bock diagram of a system 30′ for driving a display device in accordance with another example of the present invention. Referring to FIG. 3B, the system 30′ may be similar to the system 30 described and illustrated with reference to FIG. 3A except that, for example, the mapper 13 may be eliminated. An LUT 32-3 of the current example may be configured to generate a voltage level “V” in accordance with the coding algorithm in response to the first index SGL_{N-1}, the second index GL_{N} and the temperature index TI. The voltage level V may then be sent to voltage modulator 14.

In describing representative examples of the present invention, the specification may have presented the method and/or process of operating the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

It will be appreciated by those skilled in the art that changes could be made to the examples described above without departing from the broad inventive concept thereof. It is understood, therefore, that this invention is not limited to the particular examples disclosed, but it is intended to cover modifications within the spirit and scope of the present invention as defined by the appended claims.

We claim:

1. A system for driving a display device having a number of cholesteric liquid crystal (CHLC) pixels, the system comprising:
a processor configured to receive a first set of gray levels for a first image frame and a second set of gray levels for a second image frame, wherein the first set of gray levels is related to a first intensity state of each of the CHLC pixels in the first image frame and the second set of gray levels is related to a second intensity state of the each of the CHLC pixels in the second image frame; and
a look-up table (LUT) configured to output a third set of gray levels based on the first set of gray levels and the second set of gray levels, wherein the third set of gray levels is related to an addressing voltage to be written to the each of the CHLC pixels so as to change the each of the CHLC pixels from the first intensity state to the second intensity state.

2. The system of claim 1, wherein each of the third set of gray levels is related to one of voltage levels in a hysteresis region of a set of reflectance-voltage (RV) curves.

3. The system of claim 2, wherein each of the first set of gray levels is related to one of the set of RV curves and each of the second set of gray levels is related to one of reflectance levels represented by one of the set of RV curves.

4. The system of claim 3, wherein the processor is configured to identify the addressing voltage based on an intersection point of the one of the set of RV curves and the one of reflectance levels.

5. The system of claim 1 further comprising a memory to store the first set of gray levels.

6. The system of claim 1 further comprising:
a mapper configured to map each of the third set of gray levels into a voltage level.

7. The system of claim 6 further comprising:
a modulator configured to convert a voltage level from the mapper into one of a uni-polar pulse voltage, a bipolar pulse voltage and a pulse width modulation (PWM) voltage.

8. A system for driving a display device having a number of cholesteric liquid crystal (CHLC) pixels, the system comprising:
a sensor configured to detect a first set of gray levels of the CHLC pixels for a first image frame displayed on the display device, wherein the first set of gray levels is related to a first intensity state of each of the CHLC pixels in the first image frame;
a processor configured to receive a second set of gray levels for a second image frame, wherein the second set of gray levels is related to a second intensity state of the each of the CHLC pixels in the second image frame; and
a look-up table (LUT) configured to output a third set of gray levels based on the first set of gray levels from the sensor and the second set of gray levels from the processor, wherein the third set of gray levels is related to an addressing voltage to be written to the each of the CHLC pixels so as to change the each of the CHLC pixels from the first intensity state to the second intensity state.

9. The system of claim 8, wherein each of the third set of gray levels is related to one of voltage levels in a hysteresis region of a set of reflectance-voltage (RV) curves.

10. The system of claim 9, wherein each of the first set of gray levels is related to one of the set of RV curves and each of the second set of gray levels is related to one of reflectance levels represented by one of the set of RV curves.

11. The system of claim 10, wherein the processor is configured to identify the addressing voltage based on an intersection point of the one of the set of RV curves and the one of reflectance levels.

12. The system of claim 8 further comprising:
a mapper configured to map each of the third set of gray levels into a voltage level.

13. The system of claim 12 further comprising:
a modulator configured to convert a voltage level from the mapper into one of a uni-polar pulse voltage, a bipolar pulse voltage and a pulse width modulation (PWM) voltage.

14. The system of claim 7 further comprising:
a probe configured to write a set of addressing voltages to an M-th row of the CHLC pixels in an N-th image frame as the sensor detects a set of gray levels of an (M+1)-th row of the CHLC pixels in an (N−1)-th image frame, M, N being positive integers.

15. A system for driving a display device having a number of cholesteric liquid crystal (CHLC) pixels, the system comprising:
a processor configured to receive a first set of gray levels for a first image frame and a second set of gray levels for a second image frame, wherein the first set of gray levels is related to a first intensity state of each of the CHLC pixels in the first image frame and the second set of gray levels is related to a second intensity state of the each of the CHLC pixels in the second image frame;
a sensor configured to detect a third set of gray levels of the CHLC pixels for the first image frame displayed on the display device, wherein the third set of gray levels is related to a third intensity state of each of the CHLC pixels displayed in the first image frame;
a first look-up table (LUT) configured to output an index based on the first set of gray levels and the third set of gray levels, wherein the index is related to an environmental change; and
a second LUT configured to output a fourth set of gray levels based on the second set of gray levels from the processor, the third set of gray levels from the sensor and the index from the first LUT, wherein the fourth set of gray levels is related to an addressing voltage to be written to the each of the CHLC pixels so as to change the each of the CHLC pixels from the third intensity state to the second intensity state.

16. The system of claim 15, wherein each of the fourth set of gray levels is related to one of voltage levels in a hysteresis region of a set of reflectance-voltage (RV) curves.

17. The system of claim 16, wherein each of the first set of gray levels is related to one of the set of RV curves and each of the second set of gray levels is related to one of reflectance levels represented by one of the set of RV curves.

18. The system of claim 17, wherein the processor is configured to identify the addressing voltage based on an intersection point of the one of the set of RV curves and the one of reflectance levels.

19. The system of claim 15 further comprising a memory to store the first set of gray levels.

20. The system of claim 15 further comprising:
a mapper configured to map each of the fourth set of gray levels into a voltage level.

21. The system of claim 20 further comprising:
a modulator configured to convert a voltage level from the mapper into one of a uni-polar pulse voltage, a bipolar pulse voltage and a pulse width modulation (PWM) voltage.

22. The system of claim 15 further comprising:
a probe configured to write a set of addressing voltages to an M-th row of the CHLC pixels in an N-th image frame as the sensor detects a set of gray levels of an (M+1)-th row of the CHLC pixels in an (N−1)-th image frame, M, N being positive integers.
